(19) United States
(12) Patent Application Publication
(10) Pub. No.: US 2001/0027443 A1
(43) Pub. Date: Oct. 4, 2001

(54) Accounting printing system, accounting printing method, computer-readable storage medium storing accounting printing program, stencil printing apparatus, and information distributing apparatus

(76) Inventors: Hiroshi Hanzawa, Ibaraki-ken (JP); Katsumi Ohno, Ibaraki-ken (JP); Toru Hibara, Ibaraki-ken (JP); Noboru Inamine, Ibaraki-ken (JP); Susumu Oshio, Ibaraki-ken (JP)

Correspondence Address: NATH & ASSOCIATES PLLC, Sixth Floor, 1030 15th Street, N.W., Washington, DC, 20005, US

(21) Appl. No.: 09/819,686

(22) Filed: Mar. 29, 2001

(30) Foreign Application Priority Data
Apr. 3, 2000 (JP) P2000-101006
Jan. 29, 2001 (JP) P2001-20534

(51) Int. Cl. G06F 17/60

(52) U.S. Cl. 705/57; 705/59

(57) ABSTRACT

An accounting printing system according to the present invention is constituted by connecting an information distributing apparatus and a printing apparatus to each other through an electronic network. The information distributing apparatus includes; a literary work information data base for storing literary work information in a digital form; and a management information storing section for storing management information for controlling the print processing of the literary work information. The printing apparatus receives and stores the literary work information and the management information and prints the literary work information under print conditions specified in the management information.

### CROSS REFERENCE TO RELATED APPLICATION

This application claims benefit of priority under 35 U.S.C. §119 to Japanese Patent Applications No.2000-101006, filed on Apr. 3, 2000, and No.2001-20534, filed on Jan. 29, 2001, the entire contents of which are incorporated by reference herein.

### BACKGROUND OF THE INVENTION

1. Field of the Invention

The present invention relates to an accounting printing system for printing literary work digital information in a digital form having an added value, an accounting printing method, a storage medium which stores therein an accounting printing program and can be read by a computer, a stencil printing apparatus, and an information distributing apparatus. More particularly, the present invention relates to a technique for preventing the improper print processing of literary work information having an added value and protecting benefits of an owner of the literary work information by adding management information for controlling print processing such as an upper limit number of pages to be printed to the literary information to enable printing of the literary work information only under predetermined conditions.

2. Description of the Related Art

With the rapid advancement of recent digitizing techniques and printing techniques, it has become possible to easily print digitized literary work information such as newspapers, books, educational materials, illustrations, scores and various kinds of manuscripts by using an appropriate printer. Among others, a stencil printing apparatus has plenty of merits including a feature that a large number of pages, e.g., several thousands pages can be printed at a time by using one stencil sheet on which the literary work information is made up by heat perforation, and hence it has been positively led and utilized in various industries.

However, in case of performing the print processing after producing an original stencil sheet for printing the literary work information by a printer as in the stencil printing apparatus, the produced original stencil sheet remains attached on a stencil sheet core unless it is discarded. Therefore, another user who subsequently uses the apparatus prints the literary work information and the literary work information having an added value may leak to a third person unless the confidentiality operation is carried out at a time when the print processing has been completed. Thus, an owner of the literary work information may undergo disadvantages. Further, when the original stencil sheet is attached on the printing drum, a contractual number of pages or more can be printed, and this is also disadvantageous for an owner of the apparatus.

As described above, in case of printing the literary work information in a digital form by using the stencil printing apparatus, since the stencil printing apparatus has inherent processing steps for making the original stencil sheet, the literary work information having the added value can be improperly printed, thereby spoiling benefits of the owners of the literary work information and the printing apparatus as matters now stand.

### SUMMARY OF THE INVENTION

In view of the above-described technical problems in the prior art, it is therefore an object of the present invention to provide an accounting printing system for preventing the improper print processing of literary work information in a digital form having an added value and protecting benefits of owners of literary work information and a printing apparatus, an accounting printing method, a storage medium which stores therein an accounting printing program and can be read by a computer, a stencil printing apparatus, and an information distributing apparatus.

To solve the above problems, the present inventors have hit upon the idea that benefits of owners of the literary work information and the printing apparatus can be protected by adding management information, especially management information for controlling a number of pages to be printed to the literary work information in a digital form having the added value and controlling print processing in such a manner the literary work information can be printed only under predetermined conditions. Further, as a result of vigorous studies, they have made suggestion of a technical concept having the following characteristics.

That is, to achieve the above aim, there is provided an accounting printing system for printing literary work information in a digital form, wherein the literary work information includes management information for controlling a print processing of the literary work information, and the literary work information is printed under print conditions specified in the management information.

Further, to achieve the above aim, there is provided an accounting printing method for printing literary work information in a digital form, wherein the literary work information includes management information for controlling a print processing of the literary work information, and the literary work information is printed under print conditions specified in the management information.

According to these accounting printing system and method, the literary work information can be printed only under predetermined conditions, thereby protecting benefits of owners of the literary work information and the printing apparatus.

Furthermore, to achieve the above aim, there is provided an accounting printing system comprising: an information distributing apparatus for distributing literary work information in a digital form and management information for controlling a print processing of the literary work information; and a printing apparatus which is connected to the information distributing apparatus through an electronic network, receives and stores the literary work information and the management information, and prints the literary work information under print conditions specified in the management information.

In a preferred embodiment according to the present invention, the printing apparatus includes: a user information storing section for storing information on a user who utilizes the printer; an authentication processing section for authenticating a user who wants the print processing of the literary work information based on the information on the user; a controlling section for controlling the print processing of the literary work information by the authenticated user based on the information on the user and the management information; and a print processing section for printing the literary work information in response to a command from the controlling section.

In the preferred embodiment according to the present invention, the printing apparatus further includes an aggregating section for aggregating and outputting a printing fee of the literary work information. Consequently, the accounting processing involved by printing can be more efficiently carried out.

In the preferred embodiment according to the present invention, the aggregating section periodically outputs a aggregation result of the printing fee of the literary work information to the information distributing apparatus and, when the amount of the aggregation result reaches more than a predetermined amount, the controlling section controls the print processing section not to execute the print processing of the literary work information.

With such a system constitution, even if a communication line between the printing apparatus and the information distributing apparatus is disconnected, the improper print processing of the literary work information can be prevented and thus benefits of owners of the literary work information can be protected.

In the preferred embodiment according to the present invention, the printing apparatus periodically communicates with the information distributing apparatus through the electronic network and, if there is no communication between the printing apparatus and the information distributing apparatus for a predetermined period of time, the controlling section controls the print processing section not to execute the print processing of the literary work information.

With such a system constitution, even if a communication line between the printing apparatus and the information distributing apparatus is disconnected, the improper print processing of the literary work information can be prevented and thus benefits of owners of the literary work information can be protected.

In the preferred embodiment according to the present invention, the printing apparatus further includes an accounting information list generating section for generating and outputting a list of the literary work information. As a result, a user can readily select the accounting information.

Moreover, to achieve the above aim, there is provided an accounting printing method comprising: an information distributing step for distributing the literary work information in a digital form and management information for controlling a print processing of the literary work information through an electronic network; and a printing step for receiving and storing the literary work information and the management information through the electronic network, and for printing the literary work information under print conditions specified in the management information.

In addition, to achieve the above aim, there is provided a computer-readable storage medium storing an accounting printing program executed by a computer, the accounting printing program comprising: information distributing processing for distributing literary work information in a digital form and management information for controlling a print processing of the literary work information through an electronic network; and print processing for receiving and storing the literary work information and the management information through the electronic network, and for printing the literary work information under print conditions specified in the management information.

In the preferred embodiment according to the present invention, the management information controls upper limit and lower limit numbers of pages to be printed of the literary work information. As a result, the added value included in the literary work information can be assured.

In the preferred embodiment according to the present invention, the printing apparatus is a stencil printing apparatus.

Additionally, to achieve the above aim, there is provided a stencil printing apparatus for making up literary work information on a stencil sheet and printing the literary work information on print paper by using the stencil sheet, comprising: an accounting information storing section for storing the literary work information and management information for controlling a stencil print processing of the literary work information; a user information storing section for storing information of a user who utilizes the stencil printing apparatus; an authentication processing section for authenticating a user who wants the stencil print processing of the literary work information; a print processing controlling section for controlling the stencil print processing of the literary work information by the authenticated user based on the information on the user and the management information; a print processing section for executing the stencil print processing of the literary work information in accordance with a command from the print processing controlling section; and a confidentiality processing section for discarding a stencil sheet on which the literary work information is made up and wrapping a stencil sheet on which nothing is made up around a printing drum.

Further, to achieve this aim, there is provided an information distributing apparatus comprising: a literary work information storing section for storing literary work information in a digital form; a management information storing section for storing management information for controlling a print processing of the literary work information; and a controlling section for controlling transmission/reception of information to/from a printing apparatus for executing the print processing, wherein the literary work information and the management information are distributed to the printing apparatus through the controlling section.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing the structure of an accounting printing system according to an embodiment of the present invention;

FIG. 2 is a type drawing showing a data format of accounting information according to an embodiment of the present invention;

FIG. 3 is a view showing an example of an accounting printing system according to an embodiment of the present invention;

FIG. 4 is a flowchart showing user authentication processing according to an embodiment of the present invention;

FIG. 5 is a flowchart showing setting processing according to an embodiment of the present invention;

FIG. 6 is a flowchart showing stencil making processing according to an embodiment of the present invention;

FIG. 7 is a flowchart showing print processing according to an embodiment of the present invention;

FIG. 8 is a type drawing showing an overview of an information distributing apparatus according to an embodiment of the present invention.

### DESCRIPTION OF THE PREFERRED EMBODIMENTS

As described above, an accounting printing system, an accounting printing method, a computer-readable storage medium storing an accounting print processing program, a stencil printing apparatus, and an information distributing apparatus according to the present invention are prominently characterized in “adding management information for controlling the print processing of literary work information in a digital form having an added value to the literary work information and controlling the print processing of the literary work information in a printing apparatus by using this management information”.

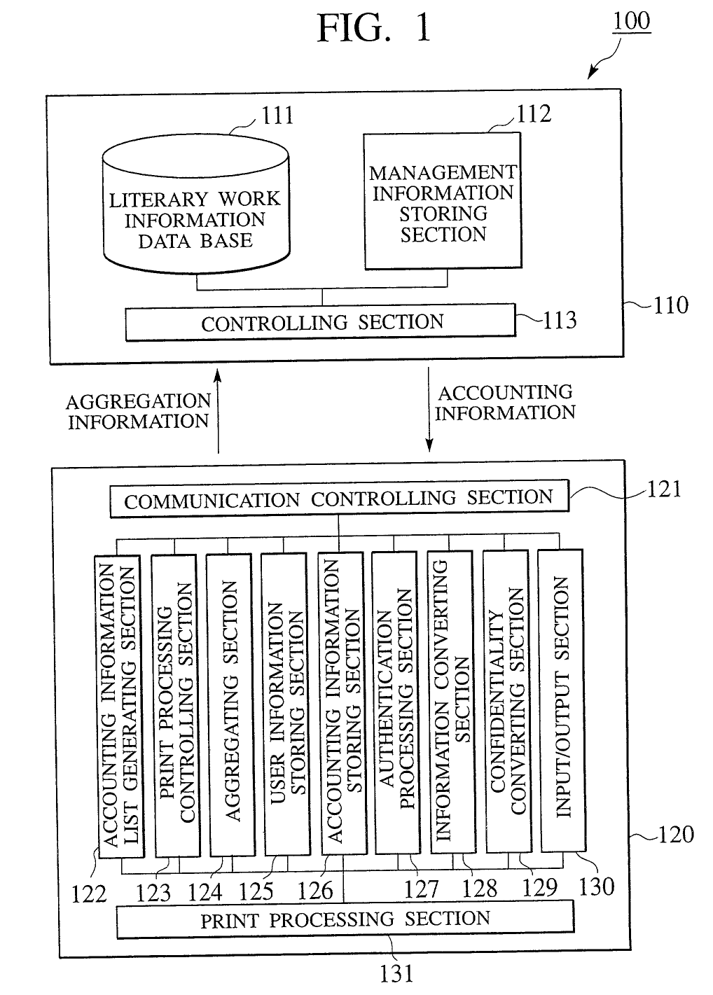

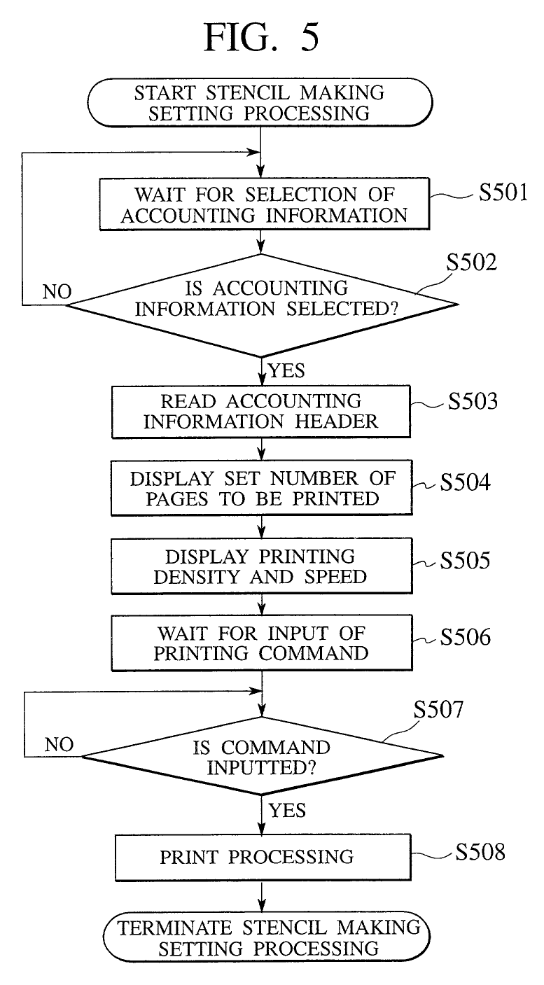

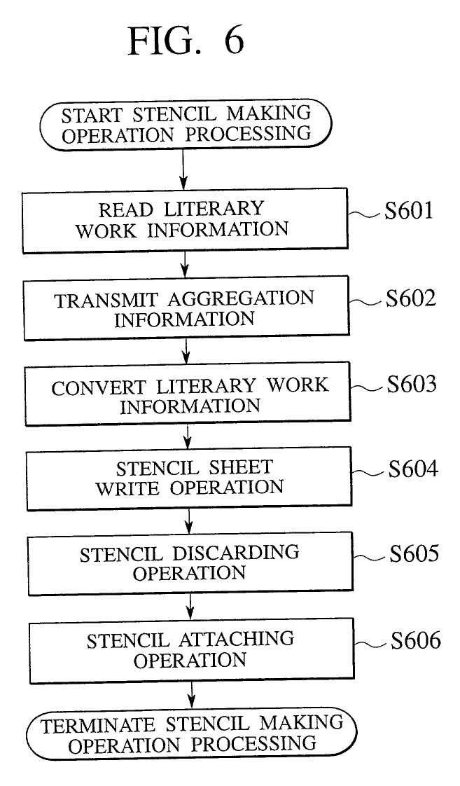

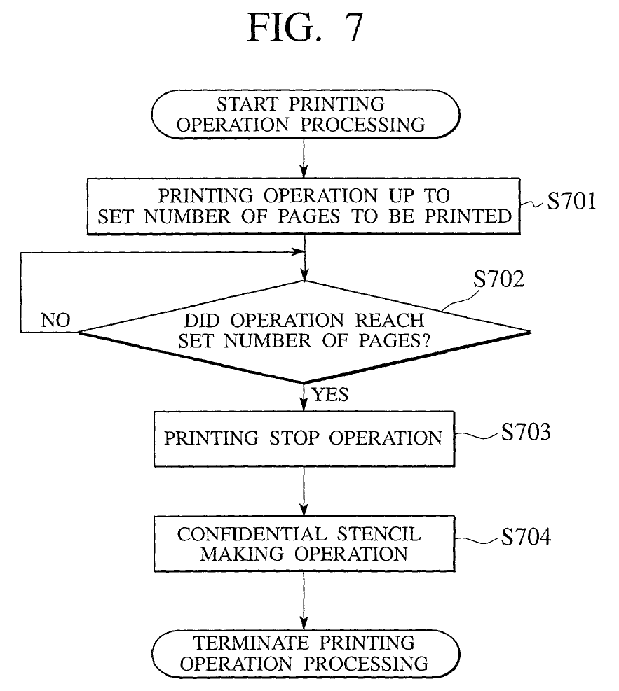

Thus, description will now be given as to the structures and results of the accounting printing system, the accounting printing method, the computer-readable storage medium storing an accounting printing program therein, the stencil printing apparatus and the information distributing apparatus according to the embodiments of the present invention, which realize this characteristic in detail hereinafter with reference to FIGS. 1 to 8.

### Accounting Printing System, Stencil Printing Apparatus, and Information Distributing Apparatus

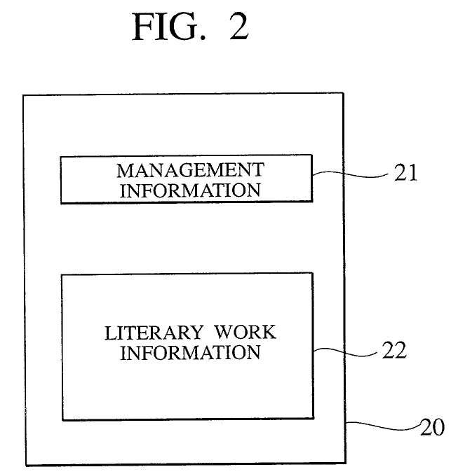

The structure of the accounting printing system according to an embodiment of the present invention will be first described with reference to FIGS. 1 and 2.

As shown in FIG. 1, the accounting printing system according to the embodiment of the present invention is constituted by: an information distributing apparatus 110 which digitizes literary work information consisting of characters, images and others, for example, newspapers, books, educational materials, illustrations, scores or manuscripts, combines the digitized information with management information for controlling the print processing of the literary work information as accounting information, and distributes the accounting information to a printing apparatus 120; and a printing apparatus 120 which receives and stores the accounting information distributed from the information distributing apparatus 110 and prints the literary work information under print conditions specified in the management information. The information distributing apparatus 110 and the printing apparatus 120 are connected to each other through an electronic network and capable of transmitting/receiving various kinds of information by utilizing the electronic network.

The information distributing apparatus 110 according to the embodiment of the present invention 110 includes: a literary work information data base 111 for storing the literary work information in the digital form; a management information storing section 112 for string therein management information for controlling the print processing of the literary work information in the printing apparatus 120, user information of the printing apparatus 120, information indicative of the availability of the literary work information by a user, and others; and a controlling section (for example, a modem) 113 for controlling transmission/reception of various kinds of information with respect to the printing apparatus 120.

The printing apparatus 120 according to the embodiment of the present invention includes: a communication controlling section (for example, a modem) 121 for controlling transmission/reception of various kinds of information with respect to the information distributing apparatus 110; an accounting information list generating section 122 for generating and outputting a list of accounting information; a print processing controlling section 123 for interpreting the management information and controlling the print processing section 131 based on the content of the management information; an aggregating section 124 for aggregating the printed literary work -information and generating and outputting aggregation information indicative of a printing fee of the literary work information by using the management information; a user information storing section 125 for storing the information of a user who utilizes the printing apparatus 120; an accounting information storing section 126 for storing accounting information; an authentication processing section 127 for executing the authentication of a user who wants the print processing of the literary work information; information converting section 128 for converting the literary work information into a data form corresponding to the printing apparatus 120; a confidentiality processing section 129 for ejecting a stencil sheet on which the printed literary work information is made up and newly wrapping a stencil sheet on which nothing is made up around a printing drum; an input/output section 130 for inputting/outputting various kinds of information concerning the accounting print processing; and a print processing section 131 for executing the print processing of the literary work information in accordance with a direction from the print processing controlling section 123.

Here, as shown in FIG. 2, the “accounting information” means information in the digital form constituted by the literary work information 22 and the management information 21 for controlling the print processing of the literary work information 22. It is determined that the management information specifically includes: an ID of the literary information (a name, a number, and a creator); presence/absence of execution of accounting relative to the print processing of the literary work information; a creation date and hour of the literary work information; an expiration date of the literary work information; an accounting unit price; upper and lower limit numbers of pages of the literary work information to be printed; an effective number of pages to be printed; a TC (Total Count: a number of pages to be printed) for each ID of the literary work information/MC (Master Count: a number of times of stencil making)/a printing date and hour; an accounting contact address; an expiration date of a target user relative to the literary work information; a group of information such as a paper size of the literary work information and others. It is to be noted that the ID of the literary work information is used for specifying print conditions such that a given user can print the literary work information having the ID numbers from 1 to 20.

Further, the “lower limit number of pages to be printed” is a parameter for controlling a number of pages of the literary work information to be printed. By setting the lower limit number of pages to be printed, the printing fee can be charged with respect to at least the number of pages to be printed set by the lower limit number of pages to be printed irrespective of printing/non-printing of the literary work information. The print processing having a number of pages to be printed equal to or lower than the lower limit number of pages to be printed can not be set, and the processing can not proceed to the next stencil making operation unless the lower limit number of pages to be printed is printed at the least. Consequently, benefits of owners of the literary work information and the printing apparatus can be assured.

Furthermore, the “expiration date of a target user relative to the literary work information” is a parameter for preventing an expired user from accessing to the literary work information. This parameter can avoid a problem that the accounting information is validated without permission at a reselling site when, for example, the printing apparatus is resold at a user's convenience.

Moreover, the “user information” includes at least information concerning the accounting processing such as a personal identification number, a position (affiliation) of a user, a number of pages printed up to the present, a number of times of use of the printing apparatus, an expiration date of a credit card, an outstanding balance in a predetermined account and others. These contents are set at the time of contract with a user when utilizing the system and can be constantly updated. It is to be noted that, in this embodiment, the user information is stored in the user information storing section 125 but the user information may be stored in the management information storing section 112 in the information distributing apparatus 110. When the user information is managed and the authentication processing is executed on the information distributing apparatus 110 side, the operation status of the literary work information by each user can be accurately grasped. On the other hand, when the user information is managed on each printing apparatus 120 side, the literary work information can be operated even if the printing apparatus is disconnected from the electronic network.

Additionally, the “electronic network” means a general communication network utilizing the telecommunications technology. For example, use of an Internet system based on TCP (Transmission Control Protocol)/IP (Internet Protocol), WAN (Wide Area Network), LAN (Local Area Network), a public telephone network, an optical fiber communication, a cable communication, a satellite communication can be considered.

Incidentally, in this embodiment, although the accounting information in the accounting information storing section 126 is supplied from the information distributing apparatus 110 through the electronic network, it may be previously stored in, e.g., a predetermined memory area (for example, a hard disk) in the printing apparatus 120 or it may be downloaded into the accounting information storing section 126 by utilizing the electronic network. In addition, the literary work information on a paper medium may be read by using a scanning type reader such as a scanner to be digitized and it may be thereafter stored in a predetermined memory area. Further, the literary work information may be supplied from a portable medium such as a floppy disk or a magnetic disk into the printing apparatus 120. Incidentally, in case of supplying the literary work information from the portable medium, it is desirable that a printing apparatus number is given to the management information so as to enable printing only in a predetermined printing apparatus and the apparatus number is verified at the time of the print processing.

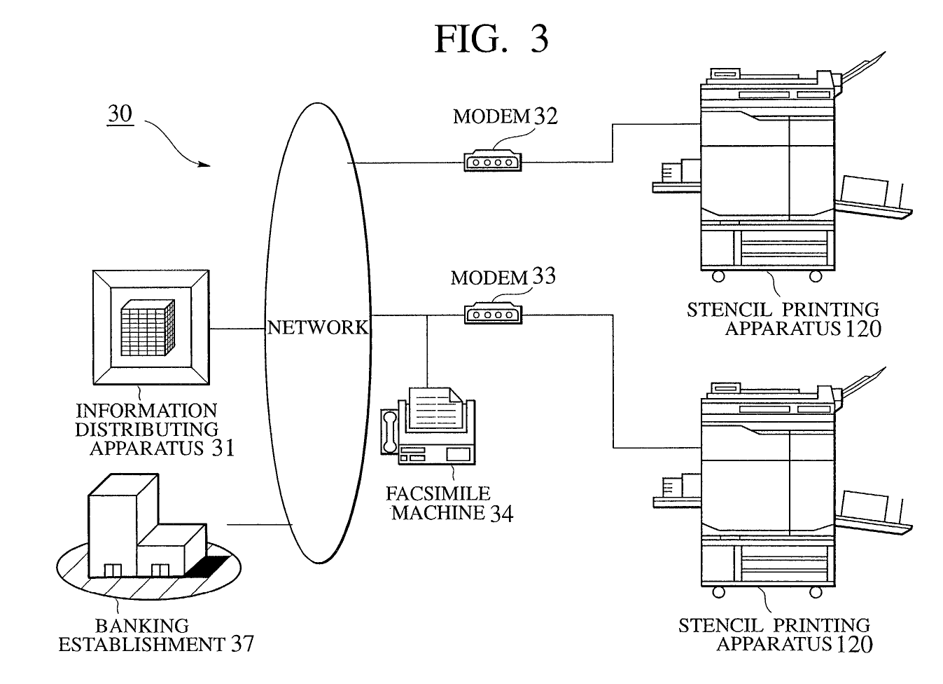

Further, when efficiently executing the accounting print processing, as shown in FIG. 3, a banking establishment 37 can be connected to the electronic network. When the banking establishment 37 carries out various transactions of business involved by the print processing of the literary work information for the system, a user can execute the processing such as direct debit of a utilization fee by using a designated account or payment of a fee by using a credit card on the electronic network so that the printing fee of the literary work information can be paid to the owner and the literary work information can be printed by the printing apparatus 120.

Furthermore, in the above embodiment, a system constitution in which information of the latest date of the access to the information distributing apparatus 110 is included in the management information and then a periodic access to the information distributing apparatus 110 is imposed may be employed. Then, if there is no access from the printing apparatus 120 to the information distributing apparatus 110, the print processing controlling section 123 refers to the date information and the expiration date of the literary work information and then, if the expiration date has passed away, executes a processing of, for example, inhibiting a use of the literary work information. With such a system constitution, even if a communication line between the printing apparatus 120 and the information distributing apparatus 110 is disconnected, the improper print processing of the literary work information can be prevented and thus benefits of owners of the literary work information can be protected.

Still further, it is desirable that the aggregating section 124 periodically transmits the aggregation information to the information distributing apparatus 110 through the electronic network and, when the amount of the aggregation information reaches more than a predetermined amount, controls the print processing controlling section 123 not to execute the print processing of the literary work information. With such a system constitution, like the above access date information in the management information, the improper print processing of the literary work information can be prevented and thus benefits of owners of the literary work information can be protected.

### Accounting Printing Method

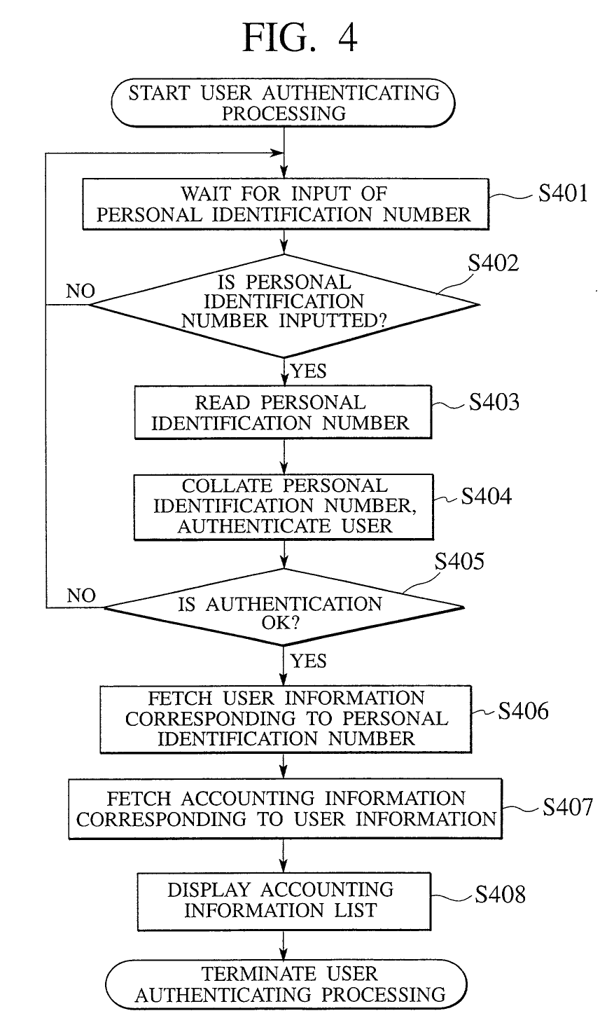

The accounting printing method according to the embodiment of the present invention can be effected by roughly four steps, i.e., (1) user authentication processing, (2) stencil making setting processing, (3) stencil making processing, and (4) print processing. Thus, description will be given as to the accounting printing method according to the embodiment of the present invention in accordance with the steps (1) to (4) with reference to FIGS. 4 to 7.

### (1) User Authentication Processing

(1-1) The printing apparatus 120 waits until a user's personal identification number (password) for using the printing apparatus 120 is inputted to the input/output section 130 (personal identification number input standby step: S401).

Here, input of the personal identification number may be direct input such as key input or touch panel type input, or the personal identification number may be indirectly inputted from a remote position through the electronic network by utilizing a remote computer system or a portable information terminal and the like.

(1-2) In response to input of the personal identification number from a user, the authentication processing section 127 reads the inputted personal identification number (personal identification number read step: S403).

(1-3) The authentication processing section 127 compares and collates the read personal identification number and a personal identification number specified in the user information in the user information storing section 125, thereby executing the user authentication (personal identification number collation and user authentication step: S404). As a result of the user authentication, if the user is authenticated, the processing proceeds to the “user information fetch step: S406” to enter the accounting print processing mode.

Incidentally, if the user can not be authenticated, the authentication processing section 127 may output to the input/output section 130 information indicative of impossibility of the user authentication such as “personal identification number is not appropriate”. Further, it is desirable to output information indicative of prompt of user registration for a user who utilizes the printing apparatus 120 for the first time. Here, if the information distributing apparatus 110 is connected through the electronic network, the user is caused to be able to execute the user registration through the electronic network.

(1-4) The accounting information list generating section 122 reads the user information concerning the authenticated user from the user information storing section 125 (user information fetch step: S406).

Here, as the user information to be read, for example, information concerning the accounting processing such as a position (affiliation) of the user, a number of pages printed up to the present; a number of times of use of the printing apparatus, an expiration date of a credit card, an outstanding balance in a predetermined account, and others is desirable.

(1-5) The accounting information list generating section 122 selects the accounting information which can be disclosed to the authenticated user based on the management information in the accounting information storing section 126, the conditions specified in the user information and others in order to generate the accounting information list (accounting information list generation step: S407).

Here, it is desirable to generate the accounting information list so as to provide a hierarchical structure in which information is classified in accordance with categories, and display a header of the accounting information in case of displaying the accounting information list to the user.

(1-6) The accounting information list generating section 122 outputs the accounting information list to the input/output section 130 (accounting information list display step: S408).

### (2) Setting Processing

(2-1) The user selects desired accounting information from the accounting information list outputted from the input/output section 130 (accounting information selection standby step: S501).

Here, a part of the literary work information included in the accounting information may be displayed on the input/output section 130 so that the user can confirm the content of the literary work information to select the accounting information.

Furthermore, as an output system for the accounting information list of the input/output section 130, a technique of the print processing and the like such as display on a screen, stencil print processing and others can be considered.

(2-2) With the selection of the accounting information by the user, the print processing controlling section 123 reads the management information concerning the selected literary work information, such as a date and time of registration, an expiration date, an effective number of pages to be printed, an attribute of the literary work information, header information and others; the management information being allocated in the header of the accounting information (accounting information header read step: S503).

(2-3) The print processing controlling section 123 reads the information concerning the effective number of pages to be printed in the management information and outputs a set number of pages to be printed to the input/output section 130 (set print page number display step: S504).

Here, as to the set number of pages to be printed, modification is generally restricted and it is desirable that the structure enabling inhibition of additional printing of a set number of copies or more (setting of an upper limit number of pages to be printed) is adopted. However, a change in a number of pages to be printed not more than a set number of pages can be accepted (the present invention does not accept this if a lower limit number of pages to be printed is set). Further, if the user has executed printing of the literary work information before, a difference from the previous number of pages printed is determined as a set number of pages to be printed (effective number of pages to be printed). Incidentally, it is desirable to enable modification of the print conditions other than the set number of pages to be printed without providing restricting matters.

(2-4) The print processing controlling section 123 reads information of print conditions such as a printing density and a printing speed in the management information and outputs the print conditions of the literary work information to the input/output section 130 (printing density and speed display step: S505).

(2-5) The print processing controlling section 123 waits until the user inputs a printing command specifying a number of pages to be printed in the literary work information and print conditions such as a printing density, a printing speed and others through the input/output section 130 (printing command input standby step: S506). In response to input of a printing command, the print processing controlling section 123 outputs the set number of pages to be printed and the print conditions to the print processing section 131.

(2-6) The print processing section 131 starts the print processing of the literary work information in accordance with the set number of pages to be printed and the print conditions (print processing step: S508). It is to be noted that the print processing described herein means the following stencil making operation processing and printing operation processing in case of the stencil print processing, and means only the printing operation processing in case of a printing apparatus of any other mode in which the stencil making operation processing is not necessary.

### (3) Stencil Making Operation Processing

(3-1) The information converting section 128 reads the literary work information in the accounting information selected by the user from the accounting information storing section 126 (literary work information read step: S601).

(3-2) The printing information controlling section 123 transmits information concerning the selected accounting information to the aggregating section 124, and the aggregating section 124 aggregates the printed literary work information based on the information in the management information and transmits it as aggregation information to an accounting contact address (information distributing apparatus or a banking establishment) specified in the management information (aggregation information transmission step: S602).

Here, the aggregation information may be transmitted upon completion of the print processing or at predetermined intervals. Further, the aggregation information may be stored in a predetermined memory area, and a manager of the printing apparatus 120 may output the aggregation information on the printing apparatus 120 side to execute the accounting transaction processing.

(3-3) The information converting section 128 converts the read literary work information into an information format suitable for making up and outputs it to the print processing section 131 (literary work information conversion step: S603).

(3-4) The print processing section 131 heats and perforates the stencil sheet in compliance with the converted literary work information and generates an original stencil sheet for printing the literary work information (stencil sheet write step: S604)

(3-5) The print processing section 131 discards the used stencil sheet which has been already attached on the printing drum (stencil sheet discarding operation step: S605).

(3-6) The print processing section 131 wraps the generated original stencil sheet around the printing drum (stencil sheet attaching operation step: S606).

### (4) Printing Operation Processing

(4-1) The print processing section 131 prints the literary work information until it reaches a set number of pages to be printed (printing operation step: S701).

(4-2) Upon completion of printing up to the set number of pages, the operation for feeding print paper is prohibited, and the print processing section 131 stops the print processing (printing stop operation step: S703).

(4-3) If the printing apparatus is a stencil printing apparatus, the print processing section 131 discards the stencil sheet and newly wraps the stencil sheet on which nothing is made up around the printing drum (confidential stencil making operation step: S704).

It is to be noted that the processing may not proceed to the confidential stencil making operation step S704 but to, e.g., the stencil making operation upon completion of the printing stop operation step S703.

As described above, according to the accounting printing system and method of the present invention, since the print processing of the literary work information having the added value can be executed only under predetermined conditions with respect to only an authenticated user, it is possible to prevent the literary work information having the added value from being printed without permission and protect rights of owners of the literary work information and the printing apparatus.

Further, the processing which automatically proceeds to the stencil remaking or the confidentiality operation upon completion of printing a predetermined number of pages can be also used for a measure against cutoff by an end surface that the stencil sheet (master) is cut by the end surface of the print paper.

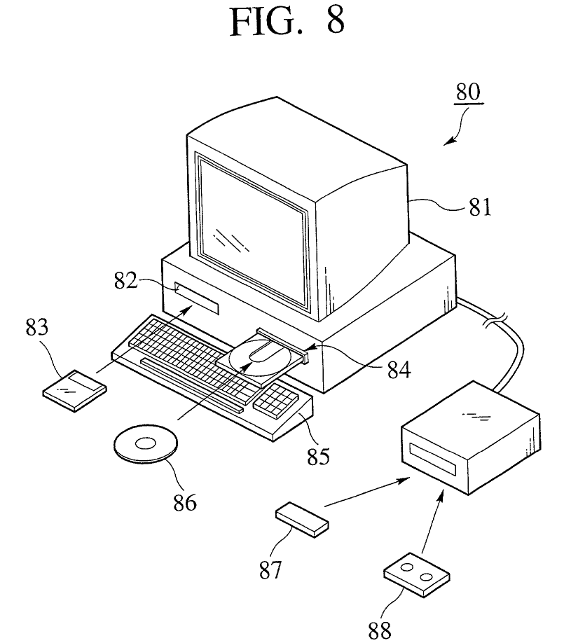

It is to be noted that the information distributing apparatus according to the embodiment of the present invention has an overview such as a structure shown in FIG. 8. That is, the information distributing apparatus according to the embodiment of the present invention is constituted by including respective constituent parts of the information distributing apparatus in a computer system 80. The computer system 80 is provided with a floppy disk drive 82 and an optical disk drive 84. A floppy disk 83 and an optical disk 86 are inserted into the floppy disk drive 82 and the optical disk drive 84 respectively, and a predetermined read operation is executed. As a result, a program stored in these storage media can be installed in the system. Further, when a predetermined drive apparatus is connected, installation or read/write of data can be executed by using a ROM 87 which serves as a memory device or a cartridge 88 which functions as a magnetic tape device. Furthermore, a user can input various kinds of input information concerning the accounting processing through a keyboard 85 and also output various kinds of output information relating to the accounting print processing through the display 81.

Moreover, the accounting printing method according to the embodiment of the present invention may be programmed and stored in a storage medium which can be read by a computer. In addition, when executing the accounting print processing, the computer system is caused to read this storage medium and store the program in a storing section such as a memory in the computer system, and the accounting program is executed by an arithmetic operation device. As a result, the accounting printing method according to the present invention can be realized. Here, the storage medium includes a medium on which a program can be recorded and which can be read by a computer, such as a semiconductor memory, a magnetic disk, an optical disk, a magnet-optical disk or a magnetic tape.

As described above, according to the accounting printing system, the accounting printing method, the computer-readable storage medium storing an accounting printing program, the stencil printing apparatus, and the information distributing apparatus of the present invention, since an environment in which the print processing of the literary work information can be executed under predetermined print conditions is provided only to an authenticated user, it is possible to prevent the literary work information having the added value from being printed without permission and carefully protect the rights of owners of the literary work information and the printing apparatus.

Additionally, according to the accounting printing system, the accounting printing method, the computer-readable storage medium storing an accounting printing program, the stencil printing apparatus, and the information distributing apparatus of the present invention, since the printing information can be distributed through the electronic network, a delivery cost of the literary work information can be reduced, and necessary literary work information can be distributed in accordance with a necessary amount, thereby easily and efficiently executing the stock management of the literary work information.

It should be understood that many modifications and adaptations of the invention will become apparent to those skilled in the art and it is intended to encompass such obvious modifications and changes in the scope of the claims appended hereto.

What is claimed is:

1. An accounting printing system for printing literary work information in a digital form, wherein said literary work information includes management information for controlling a print processing of said literary work information, and said literary work information is printed based under print conditions specified in said management information.

2. The accounting printing system according to claim 1, wherein said management information controls upper and lower limit numbers of pages to be printed of said literary work information.

3. An accounting printing method for printing literary work information in a digital form, wherein said literary work information includes management information for controlling a print processing of said literary work information, and said literary work information is printed under print conditions specified in said management information.

4. The accounting printing method according to claim 3, wherein said management information controls upper and lower limit numbers of pages to be printed of said literary work information.

5. An accounting printing system comprising:
an information distributing apparatus for distributing literary work information in a digital form and management information for controlling a print processing of said literary work information; and
a printing apparatus which is connected to said information distributing apparatus through an electronic network, receives and stores said literary work information and said management information, and prints said literary work information under print conditions specified in said management information.

6. The accounting printing system according to claim 5, wherein
said printing apparatus includes:
a user information storing section for storing information on a user who utilizes said printing apparatus;
an authentication processing section for executing authentication of a user who wants the print processing of said literary work information based on said information on said user;
a controlling section for controlling the print processing of said literary work information by an authenticated user based on said information on said user and said management information; and
a print processing section for printing said literary work information in accordance with a command from said controlling section.

7. The accounting printing system according to claim 5, wherein said management information controls upper and lower limit numbers of pages to be printed of said literary work information.

8. The accounting printing system according to claim 6, wherein said printing apparatus further includes an aggregating section for aggregating and outputting a printing fee of said literary work information.

9. The accounting printing system according to claim 8, wherein said aggregating section periodically outputs a aggregation result of the printing fee of said literary work information to said information distributing apparatus and, when the amount of the aggregation result reaches more than a predetermined amount, said controlling section controls said print processing section not to execute the print processing of said literary work information.

10. The accounting printing system according to claim 6, wherein said printing apparatus periodically communicates with said information distributing apparatus through the electronic network and, if there is no communication between said printing apparatus and said information distributing apparatus for a predetermined period of time, said controlling section controls said print processing section not to execute the print processing of said literary work information.

11. The accounting printing system according to claim 6, wherein said printing apparatus further includes an accounting information list generating section for generating and outputting a list of said literary work information.

12. The accounting printing system according to claim 5, wherein said printing apparatus is a stencil printing apparatus.

13. An accounting printing method comprising:
an information distributing step for distributing literary work information in a digital form and management information for controlling a print processing of said literary work information through an electronic network; and
a printing step for receiving and storing said literary work information and said management information through said electronic network, and for printing said literary work information under print conditions specified in said management information.

14. The accounting printing method according to claim 13, wherein said printing step includes:
a user information storing step for storing information on a user who utilizes said printing apparatus;
an authentication processing step for executing authentication of a user who wants the print processing of said literary work information based on said information on said user;
a controlling step for controlling the print processing of said literary work information by an authenticated user based on said information on said user and said management information; and
a print processing step for printing said literary work information in accordance with a command from said controlling step.

15. The accounting printing method according to claim 13, wherein said management information controls upper and lower limit numbers of pages to be printed of said literary work information.

16. The accounting printing method according to claim 14, wherein said printing step further includes an aggregating step for aggregating and outputting a printing fee of said literary work information.

17. The accounting printing method according to claim 14, wherein said printing step further includes an accounting information list generating step for generating and outputting a list of said literary work information.

18. A computer-readable storage medium storing an accounting printing program which can be executed by a computer, said accounting printing program comprising:
information distributing processing for distributing literary work information in a digital form and management information for controlling a print processing of said literary work through an electronic network; and
print processing for receiving and storing said literary work information and said management information through said electronic network, and for printing said literary work information under print conditions specified in said management information.

19. The computer-readable storage medium storing an accounting printing program according to claim 18, wherein said print processing includes:
user information storing processing for storing information on a user who utilizes said printing apparatus;
authentication processing for executing authentication of a user who wants the print processing of said literary work information based on said information on said user;
controlling processing for controlling the print processing of said literary work information by an authenticated user based on said information on said user and said management information; and
print processing for printing said literary work information in accordance with a command from said controlling processing.

20. The computer-readable storage medium storing an accounting printing program according to claim 18, wherein said management information controls upper and lower limit numbers of pages to be printed of said literary work information.

21. The computer-readable storage medium storing an accounting printing program according to claim 19, wherein said print processing further includes aggregating processing for aggregating and outputting a printing fee of said literary work information.

22. The computer-readable storage medium storing an accounting printing program according to claim 19, wherein said print processing further includes accounting information list processing for generating and outputting a list of said literary work information.

23. A stencil printing apparatus for making up literary work information on a stencil sheet and printing said literary work information on print paper by using said stencil sheet, comprising:
an accounting information storing section for storing said literary work information and management information for controlling a stencil print processing of said literary work information;
a user information storing section for storing information on a user who utilizes said stencil printing apparatus;
an authentication processing section for executing authentication of a user who wants the stencil print processing of said literary work information based on said information on said user;
a print processing controlling section for controlling the stencil print processing of said literary work information by an authenticated user based on said information on said user and said management information;
a print processing section for executing the stencil print processing of said literary work information in accordance with a command from said print processing controlling section; and
a confidentiality processing section for discarding a stencil sheet on which said literary work information is made up after the completion of the stencil print processing, and for wrapping a stencil sheet on which nothing is made up around a printing drum.

24. The stencil printing apparatus according to claim 23, wherein said management information controls upper and lower limit numbers of pages to be printed of said literary work information.

25. The stencil printing apparatus according to claim 23, further comprising an aggregating section for aggregating and outputting a printing fee of said literary work information.

26. The stencil printing apparatus according to claim 23, further comprising an accounting information list generating section for generating and outputting a list of said literary work information.

27. An information distributing apparatus comprising:
a literary work information storing section for storing a literary work in a digital form;
a management information storing section for storing management information for controlling a print processing of said literary work information; and
a controlling section for controlling transmission/reception of information to/from a printing apparatus for executing said print processing,
wherein said literary work information and said management information are distributed to said printing apparatus through said controlling section.
